(19) United States
(12) Patent Application Publication
(10) Pub. No.: US 2013/0308941 A1
(43) Pub. Date: Nov. 21, 2013

(54) Energy Efficient Ethernet Network Capability and Feature Exchange in Optical Network Links

(71) Applicant: BROADCOM CORPORATION, Irvine, CA (US)

(72) Inventor: Wael William Diab, San Francisco, CA (US)

(73) Assignee: BROADCOM CORPORATION, Irvine, CA (US)

(21) Appl. No.: 13/624,963

(22) Filed: Sep. 23, 2012

Related U.S. Application Data
(60) Provisional application No. 61/647,905, filed on May 16, 2012.

(51) Int. Cl. H04J 14/00

(52) U.S. Cl. 398/45

(57) ABSTRACT

In interfaces such as optical physical layer devices that do not support auto-negotiation, configuration of an energy efficiency Ethernet operation can be enabled through higher-layer protocol messaging that advertises energy efficiency capabilities and features between link partners. The higher-layer protocol messaging occurs after optical communication is established.

This application claims priority to provisional patent application No. 61/647,905, filed May 16, 2012, which is incorporated by reference herein, in its entirety, for all purposes.

### BACKGROUND

1. Field of the Invention

The present invention relates generally to networking and, more particularly, to a an energy efficient Ethernet network capability and feature exchange in optical network links.

2. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy efficient networks (IEEE 802.3az) has arisen to address the rising costs of IT equipment usage as a whole (i.e., PCs, displays, printers, switches, servers, network equipment, etc.).

In designing an energy efficient solution, one of the considerations is network link utilization. For example, many network links are typically in an idle state between sporadic bursts of data traffic. An additional consideration for an energy efficient solution is the extent to which the traffic is sensitive to buffering and latency. For example, some traffic patterns (e.g., HPC cluster or high-end 24-hr data center) are very sensitive to latency such that buffering would be problematic.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an Ethernet link between link partners.

FIG. 2 illustrates an example of a LLDP Data Unit.

FIG. 3 illustrates a flowchart of an example process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Energy efficient Ethernet networks attempt to save power when the traffic utilization of the network is not at its maximum capacity. In interfaces such as optical physical layer devices that do not support auto-negotiation, configuration of an energy efficiency Ethernet operation can be enabled through link layer protocol messaging that advertises energy efficiency capabilities and features between link partners. In one embodiment, a first link partner first establishes optical communication with a second link partner, which is coupled to the first link partner via a fiber optic network cable. After communication is established, the first link partner can then transmit a link layer protocol packet from to the second link partner via the fiber optic network cable. In one embodiment, the link layer protocol packet is a Link Layer Discovery Protocol (LLDP) message packet. The link layer protocol packet that is transmitted by the first link partner can be used to advertise support by the first link partner of an energy efficiency protocol. In various embodiments, the supported energy efficiency protocol enables support for one or more energy efficiency operating modes (e.g., low power idle mode, subset physical layer device mode, etc.) that have a reduced power consumption relative to an active operating mode of the first link partner. Upon receipt by the first link partner of a second link layer protocol packet from the second link partner over the fiber optic network cable, the first link partner can then activate energy efficiency features. In one embodiment, the first link partner activates a energy efficiency state machine that governs the behavior of the energy efficiency control protocol.

In general, the energy efficiency control protocol can be used to minimize a transmission performance impact while maximizing energy savings. At a broad level, an energy efficiency control policy for a particular link in the network determines when to enter an energy saving state, what energy saving state (i.e., level of energy savings) to enter, how long to remain in that energy saving state, what energy saving state to transition to out of the previous energy saving state, etc. In one embodiment, energy efficiency control policies can base these energy-saving decisions on a combination of settings established by an IT manager and the properties of the traffic on the link itself

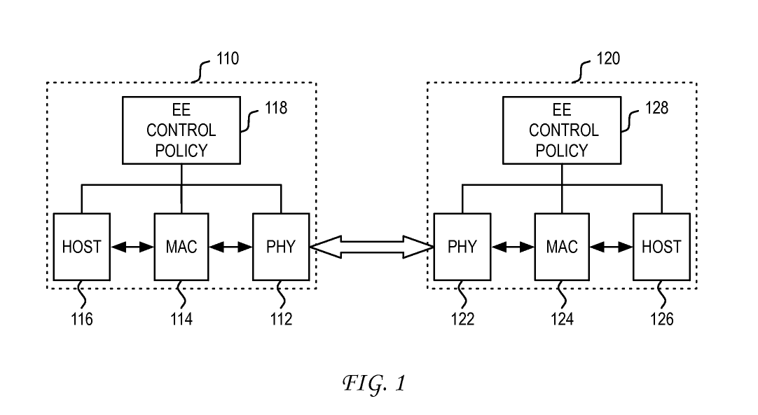

FIG. 1 illustrates an example link to which an energy efficiency control policy can be applied. As illustrated, the link supports communication between a first link partner 110 and a second link partner 120. In various embodiments, link partners 110 and 120 can represent a switch, router, endpoint (e.g., server, client, VOIP phone, wireless access point, etc.), or the like. As illustrated, link partner 110 includes physical layer device (PHY) 112, media access control (MAC) 114, and host 116, while link partner 120 includes PHY 122, MAC 124, and host 126.

In general, hosts 116 and 126 may comprise suitable logic, circuitry, and/or code that may enable operability and/or functionality of the five highest functional layers for data packets that are to be transmitted over the link. Since each layer in the OSI model provides a service to the immediately higher interfacing layer, MAC controllers 114 and 124 may provide the necessary services to hosts 116 and 126 to ensure that packets are suitably formatted and communicated to PHYs 112 and 122, respectively. MAC controllers 114 and 124 may comprise suitable logic, circuitry, and/or code that may enable handling of data link layer (Layer 2) operability and/or functionality. MAC controllers 114 and 124 can be configured to implement Ethernet protocols, such as those based on the IEEE 802.3 standard, for example. PHYs 112 and 122 can be configured to handle physical layer requirements, which include, but are not limited to, packetization, data transfer and serialization/deserialization (SERDES).

As FIG. 1 further illustrates, link partners 110 and 120 also include energy efficiency control policy entities 118 and 128, respectively. In general, energy efficiency control policy entities 118 and 128 can be designed to determine when to enter an energy saving state, what energy saving state (i.e., level of energy savings) to enter, how long to remain in that energy saving state, what energy saving state to transition to out of the previous energy saving state, etc.

In general, energy efficiency control policy entities 118 and 128 can comprise suitable logic, circuitry, and/or code that may be enabled to establish and/or implement an energy efficiency control policy for the network device. In various embodiments, energy efficiency control policy entities 118 and 128 can be a logical and/or functional block which may, for example, be implemented in one or more layers, including portions of the PHY or enhanced PHY, MAC, switch, controller, or other subsystems in the host, thereby enabling energy-efficiency control at one or more layers.

In one example, energy efficient Ethernet such as that defined by IEEE 802.3az can provide substantial energy savings through the use of a low power idle mode and/or subrating. In general, the low power idle mode can be entered when a transmitter enters a period of silence when there is no data to be sent. Power is thereby saved when the link is off. Refresh signals can be sent periodically to enable wake up from the sleep mode.

Subrating can be used to reduce the link rate to a sub-rate of the main rate, thereby enabling a reduction in power. In one example, this sub-rate can be a zero rate, which produces maximum power savings.

One example of subrating is through the use of a subset PHY technique. In this subset PHY technique, a low link utilization period can be accommodated by transitioning the PHY to a lower link rate that is enabled by a subset of the parent PHY. In one embodiment, the subset PHY technique is enabled by turning off portions of the parent PHY to enable operation at a lower or subset rate (e.g., turning off three of four channels). In another embodiment, the subset PHY technique can be enabled by slowing down the clock rate of a parent PHY. For example, a parent PHY having an enhanced core that can be slowed down and sped up by a frequency multiple can be slowed down by a factor of 10 during low link utilization, then sped up by a factor of 10 when a burst of data is received. In this example of a factor of 10, a 10G enhanced core can be transitioned down to a 1G link rate when idle, and sped back up to a 10G link rate when data is to be transmitted.

In general, both the subrating and low power idle techniques involve turning off or otherwise modifying portions of the PHY during a period of low link utilization. As in the PHY, power savings in the higher layers (e.g., MAC) can also be achieved by using various forms of subrating as well.

Configuration of energy efficiency functionality in network devices can be limited where the network devices do not support physical layer auto-negotiation techniques. For example, auto-negotiation support in optical PHYs has been limited due in part to the different wavelengths of optical signaling that are used between systems. For this reason, only the 1000BASE-X fiber optic media system has a defined auto-negotiation specification that allows the link partners on a gigabit Ethernet fiber optic link to determine the modes of operation they support in common. The limited support of auto-negotiation in optical PHYs therefore presents a barrier to energy efficiency adoption in fiber optic cable installations.

It is therefore a feature of the present invention that higher-layer protocol messaging can be used to enable energy efficient Ethernet network capability and feature exchange between link partners in an optical network link. In one example, the higher-layer protocol is a link-layer protocol such as Link Layer Discovery Protocol (LLDP). As would be appreciated, various other higher-layer protocols can be used without departing from the scope of the present invention. Here, it should be noted that the particular protocol that is used is at a layer above the physical layer.

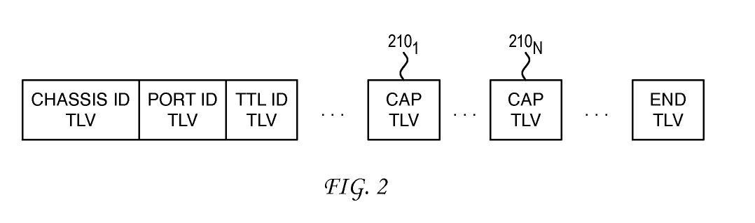

In one embodiment, LLDP messaging according to the present invention can be based on formatted TLVs (type-length-value) that are defined for communication of energy efficiency control policy capabilities between link partners. The formatted TLVs can be carried within a LLDP frame that is based on an LLDP Data Unit (LLDPDU). As illustrated in FIG. 2, the LLDPDU can include a Chassis ID TLV, Port ID TLV, and Time To Live (TTL) TLVs. Additionally, the LLDPDU can also include a plurality of energy efficiency control policy capabilities (CAP) TLVs 210₁-210_{N}.

In general, CAP TLVs 210₁-210_{N} are configured to advertise energy efficiency control policy features/capabilities that are supported by a link partner. As would be appreciated, a particular link partner can include a PHY that supports a different iteration of an evolving set of energy efficiency control policy features/capabilities as compared to the PHY in its link partner. For example, one PHY may support one type of subrating (e.g., LPI mode) while another PHY may be configured to support a different type of subrating (e.g., subset PHY mode). Even within a given type of subrating, different PHYs can support different capabilities, such as wake up times from a given energy efficiency operating mode.

As would be appreciated, numerous variations in energy efficiency control policy features/capabilities can be supported across various link partner devices. Here, what is significant is that the leveraging on any such energy efficiency control policy features/capabilities would be dependent on a mechanism to form an agreement between link partners on energy efficiency control policy features/capabilities that will be implemented in a given link.

It is a feature of the present invention that the various features/capabilities are advertised to a link partner using a protocol such as LLDP. In this example, one or more CAP TLVs 210₁-210_{N} are used to advertise a particular set of features/capabilities that are supported by the advertising device. As would be appreciated, the particular data variables used to advertise a set of features/capabilities would be implementation dependent. Here, it is significant that the advertisement of such features/capabilities using a protocol such as LLDP would enable link partners in an optical communication link to coordinate energy savings initiatives being implemented in the optical communication link. Further efficiency in the link partner configuration process is therefore enabled.

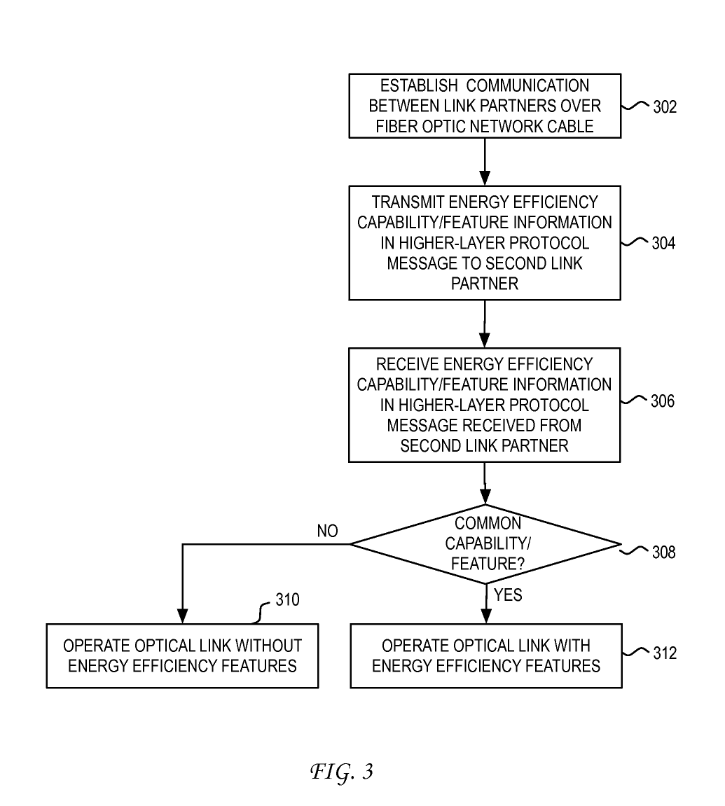

To further illustrate the features of the present invention, reference is now made to FIG. 3, which illustrates a flowchart of an example process that uses higher-layer protocol messaging to facilitate energy savings initiatives in an optical communication link.

As illustrated, the process begins at step 302 where communication is established between link partners over an fiber optic network cable. Here, it should be noted that the energy efficiency capabilities and feature exchange is deferred until the fiber optic link is already established. This deferral of the energy efficiency Ethernet capabilities and feature exchange enables the rapid deployment of energy efficiency support into new optical interfaces that are defined into the future.

After communication is established on the optical link, the process then proceeds to step 304 where energy efficiency capabilities and feature information is transmitted from a first link partner to a second link partner using a higher-layer protocol message. As noted above, an example of such a higher-layer protocol is LLDP. As would be appreciated, various other higher-layer protocols can be used without departing from the scope of the present invention. Here, it should be noted that the particular protocol that is used is at a layer above the physical layer.

Next, at step 306, a higher-layer protocol message is received from the second link partner. Here, it should be noted that the receipt of a higher-layer protocol message from the second link partner can occur concurrently or subsequent to the higher-layer protocol message that is transmitted to the second link partner at step 304. As would be appreciated, the timing of the receipt of the higher-layer protocol message from the second link partner would be dependent upon the initialization procedures within the second link partner.

In one embodiment, the variance in the initialization procedures between link partners can be accommodated by re-sending a higher-layer protocol message after a first time-out period has expired. This re-sending ensures that the higher-layer protocol message has been received by the second link partner after the relevant components in the second link partner that are responsive to the higher-layer protocol message have been initialized and activated. In one embodiment, if a higher-layer protocol message has not been received from the second link partner after the expiration of a second defined time-out period, then the first link partner can determine that the second link partner does not support energy efficiency capabilities and features. Such being the case, the link partner can then commence data transmission over the optical communication link without the benefit of any energy savings during low link utilization periods.

Where a higher-layer protocol message containing energy efficiency capabilities and feature information is received from the second link partner, the first link partner can then use the information contained therein to activate the relevant energy efficiency capabilities and features within the first link partner. Here, at step 308, a determination can be made based on the exchanged energy efficiency capabilities and feature information of whether there are common energy efficiency capabilities and/or features between the two link partners.

If it is determined that there are no common energy efficiency capabilities and/or features between the two link partners, then the optical link can be operated at step 310 without any energy efficiency features. If, on the other hand, it is determined that there are common energy efficiency capabilities and/or features between the two link partners, then the optical communication link can be operated with those energy efficiency features at step 312. For example, the activated energy efficiency capabilities and/or features can include a subset PHY mode, a LPI mode, or any other capability/feature that is in common between the first and second link partner. In one embodiment, activation of those energy efficiency capabilities and/or features is based on an activation of a state machine that governs the energy efficiency control policy.

As would be appreciated, the particular types of supported capabilities and/or features that are communicated between link partners using higher-layer protocol messages would be implementation dependent. In general, the higher-layer protocol messages can be used to communicate any information over the optical communication link that can impact the initialization, operation, adaption, etc. of an energy efficiency control policy.

In one embodiment, after the energy efficiency capabilities and/or features have been activated, the first link partner can wait a defined period of time before communicating energy efficiency control information to the second link partner. This ensures that the energy efficiency capabilities and/or features in the second link partner is properly activated by the second link partner in response to the higher-layer messaging exchange.

In one embodiment, configuration of energy efficient Ethernet functionality on an optical link can also leverage the auto-negotiation capabilities supported by the 1000BASE-X fiber optic media system.

In another embodiment, the capability exchange can use an LPI protocol exchange without power-down of the physical medium dependent (PMD) sublayer of the PHY. For example, LPI codewords can be used for signaling.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method, comprising:
establishing, by a first link partner, optical communication with a second link partner via a fiber optic network cable;
after said establishing, transmitting a first link layer protocol packet from said first link partner to said second link partner via said fiber optic network cable, said first link layer protocol packet advertising first energy efficiency control policy capabilities that are supported by said first link partner;
after said establishing, receiving a second link layer protocol packet by said first link partner from said second link partner via said fiber optic network cable, said second link layer protocol packet advertising second energy efficiency control policy capabilities that are supported by said second link partner; and
based on a comparison of said first energy efficiency control policy capabilities that are supported by said first link partner and said second energy efficiency control policy capabilities that are supported by said second link partner, activating a state machine that governs an energy efficiency control policy in said first link partner, said energy efficiency control policy enabling support for an energy efficiency operating mode that has a reduced power consumption relative to an active operating mode of said first link partner.

2. The method of claim 1, wherein said link layer protocol packet is a Link Layer Discovery Protocol (LLDP) packet.

3. The method of claim 1, wherein said energy efficiency operating mode is a low power idle mode.

4. The method of claim 1, wherein said energy efficiency operating mode is a subset physical layer device mode.

5. The method of claim 1, further comprising resending said first link layer protocol packet when said second link layer protocol packet is not received from said second link partner in a predetermined time period.

6. A method, comprising:
establishing, by a first link partner, optical communication with a second link partner via a fiber optic network cable;
prior to activation of a controller that governs an energy efficiency control policy in said first link partner, transmitting a first link layer protocol packet from said first link partner to said second link partner via said fiber optic network cable, said first link layer protocol packet advertising first energy efficiency control policy capabilities that are supported by said first link partner;
prior to activation of said controller that governs said energy efficiency control policy in said first link partner, receiving a second link layer protocol packet by said first link partner from said second link partner via said fiber optic network cable, said second link layer protocol packet advertising second energy efficiency control policy capabilities that are supported by said second link partner; and
based on a comparison of said first energy efficiency control policy capabilities that are supported by said first link partner and said second energy efficiency control policy capabilities that are supported by said second link partner, activating said controller in implementing said energy efficiency control policy enabling support for an energy efficiency operating mode that has a reduced power consumption relative to an active operating mode of said first link partner.

7. The method of claim 6, wherein said link layer protocol packet is a Link Layer Discovery Protocol (LLDP) packet.

8. The method of claim 6, wherein said energy efficiency operating mode is a low power idle mode.

9. The method of claim 6, wherein said energy efficiency operating mode is a subset physical layer device mode.

10. A method, comprising:
establishing, by a first link partner, communication with a second link partner, said first link partner being coupled to said second link partner via a fiber optic network cable; and
after said establishing, transmitting a link layer protocol packet from said first link partner to said second link partner via said fiber optic network cable, said link layer protocol packet advertising a support by said first link partner of an energy efficiency control protocol that enables support for an energy efficiency operating mode that has a reduced power consumption relative to an active operating mode.

11. The method of claim 10, wherein said establishing comprises establishing a gigabit network link.

12. The method of claim 10, wherein said establishing comprises establishing a 10 gigabit network link.

13. The method of claim 10, wherein said establishing comprises establishing a 40 gigabit network link.

14. The method of claim 10, wherein said establishing comprises establishing a 100 gigabit network link.

15. The method of claim 10, wherein said link layer protocol packet is a Link Layer Discovery Protocol (LLDP) packet.

16. The method of claim 10, wherein said link layer protocol packet includes information that identifies one or more energy efficiency features supported by said first link partner.

17. The method of claim 10, wherein said energy efficiency operating mode is a low power idle mode.

18. The method of claim 10, wherein said energy efficiency operating mode is a subset physical layer device mode.

19. The method of claim 10, further comprising activating a state machine in said first link partner that governs said energy efficiency protocol upon receipt of a second link layer protocol packet from said second link partner, said second link layer protocol packet advertising a support by said second link partner of said energy efficiency protocol.

20. The method of claim 10, further comprising resending said link layer protocol packet when a second link layer protocol packet is not received from said second link partner in a predetermined time period.
